(19) United States
(12) Patent Application Publication
(10) Pub. No.: US 2003/0233414 A1
(43) Pub. Date: Dec. 18, 2003

(54) Digital transmitting from remote capture

(76) Inventor: Steven G. Henry, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/172,144

(22) Filed: Jun. 13, 2002

(51) Int. Cl. G06F 15/16

(52) U.S. Cl. 709/206

(57) ABSTRACT

A digital transmitter device to scan and send an image along with instructions to a network device to transmit the image to an electronic address, including an address of a network resource and a destination location thereat, designated by the digital transmitter device.

### FIELD OF THE INVENTION

The present invention relates generally to peripheral devices, and more particularly to a digital transmitter device to scan and send an image along with instructions to a network device to transmit the image to an electronic address designated by the digital transmitter device.

### BACKGROUND OF THE INVENTION

Many peripherals to computer networks include a scanner component. One example of such a peripheral is an “All-in-one”, also known as a multifunction peripheral (MFP) in that it has the capability to perform the multiple functions of scanning hardcopy documents, copying, and printing. Another example is a digital network copier that scans in documents from an automatic document feeder, does high volume copying, and has the capabilities of binding, collating, folding, stacking, stapling, stitching, edge-trimming, paginating, and printing on substrates of varied composition. Each of these peripherals, when in communication with an interconnecting network, can also be described as being a digital transmitter device. A digital transmitter device is an appliance that has an input device (e.g. a keyboard), a display, and a scanner. The digital transmitter device need not have a printer. A digital camera is a type of digital transmitter device, but in comparison to the foregoing, it is not as useful for handling documents and typically lacks the resolution and ability to rapidly and repetitively transfer information after scanning to a repository.

In an exemplary digital transmitting operation, a hardcopy of a document or other physical object can be presented to the scanner portion of a digital transmitter device. After scanning, the digital transmitter device transforms the scanned image into a digital representation that is then saved in a data format, such as in a bit map data format or in a Portable Document Format (PDF). Electronic messaging can be used to send an electronic mail (e-mail) message from the digital transmitter device with an attachment of the digitized representation in the data format. The e-mail message can be sent to recipients over the interconnecting network, where the recipients have an e-mail address that a user manually enters at the digital transmitter device or that a user specifies using a predefined defined list of recipient e-mail addresses that can be stored in a memory of the digital transmitter device.

Digital transmitter devices today are considered fixed devices that are tethered to a power supply and may also be tethered to an interconnected network. As such, a hardcopy of a document or other physical object must be brought to the scanner portion of the digital transmitter device before an image thereof can be captured and subsequently transmitted to an e-mail address on the interconnected network. It would be beneficial to minimize the transportation requirements for the hardcopy of the document or other physical objects that are condition precedent to the capture and transmission of image thereof to an e-mail address. Consequently, there is a need for improved methods, apparatuses, systems, and programs that can provide such a capability.

### SUMMARY OF THE INVENTION

The above-stated needs and/or others are met, for example, by methods, apparatuses, systems, and programs that use a scanner to capture and send an image along with instructions to a network device to transmit to the image to an electronic address designated by the scanner that includes an address of a network resource and a destination location thereat.

These and other features of the present invention will become more fully apparent from the following description and appended claims, or may be learned by the practice of the invention as set forth hereinafter.

### DESCRIPTION OF THE DRAWINGS

A more complete understanding of the various methods, apparatuses, systems, and programs of the present invention may be had by reference to the following detailed description when taken in conjunction with the accompanying drawings wherein the same reference numbers are used throughout the drawings to reference like components and features, and wherein:

FIG. 1a is a block diagram, according to an embodiment of the present invention, depicting a computing and communication environment having digital transmitter devices in a system environment suitable for providing local access to the digital transmitter devices.

FIG. 1b illustrates various digital transmitter devices that provide local access for input thereto according to an embodiment of the present invention.

FIG. 2 is a block diagram, according to an embodiment of the present invention, illustrating a digital transmitter device in communication with a network device through a wired or wireless link, where the network device is in communication through an interconnecting network to an electronic mail (e-mail) server.

FIG. 3 illustrates an example of menu pages that might be displayed on a touch sensitive menu screen of a digital transmitter device and transition sequences among the menu pages, according to an embodiment of the present invention.

FIG. 4 is a flow diagram, according to an embodiment of the present invention, depicting a method for use in a computing and communication environment having a digital transmitter device in a system as in FIG. 1, for example, in accordance with certain exemplary embodiments of the present invention.

### DETAILED DESCRIPTION

The methods, apparatuses, systems, and programs described herein, according to various embodiments of the present invention, relate to the transmission of message data in an electronic mail (e-mail) from a digital transmitter device to a specific e-mail address. The message data includes an image that is captured by the digital transmitter device using a scanning mechanism. The message data also includes a designated e-mail address and instructions. The instructions direct a network device to transmit the captured image over a network to the designated e-mail address. The digital transmitter device then transmits the message data to the network device by a link that can be either wired or wireless. The network device is in communication with an e-mail server for the designated e-mail address through an interconnected network. Once the network device receives the message data, it follows the instructions therein to transmit the captured image to the designated e-mail address associated with the e-mail server. Typically, the network device opens a connection with the e-mail server for the designated e-mail address, then addresses the message data using the designated e-mail address, and transmits the message data to the e-mail address at the e-mail server.

In one embodiment of the present invention, the digital transmitter device can include an input device that a user can use to input the designated e-mail address or to select the designated e-mail address from among a list of e-mail addresses stored in the digital transmitter device. The input device can be a keyboard, a touch sensitive menu screen, or other conventional input mechanism. A display, such as a touch sensitive menu screen, can display a menu page having selectable menu items. These menu items can include a menu item to input the designated e-mail address using the input device, and a menu item to perform a scan function using the scanning mechanism. It is preferred that the digital transmitter device include a processor for execution of respective programs associated with each selected menu item, where the selection of one of the menu items initiates the execution of a respective program by the processor. When the scanning menu item is selected, the digital transmitter device captures an image with the scanning mechanism by optically scanning an object to form corresponding scanned object data. The digital transmitter device can form in message data both the designated e-mail address and the scanned object data for subsequent transmission as described above. The subsequent transmission from the digital transmitter device to the network device can be over a channel that is established by a wireless or a wired link.

### Exemplary System for Configuration of a Digital Transmitter Device

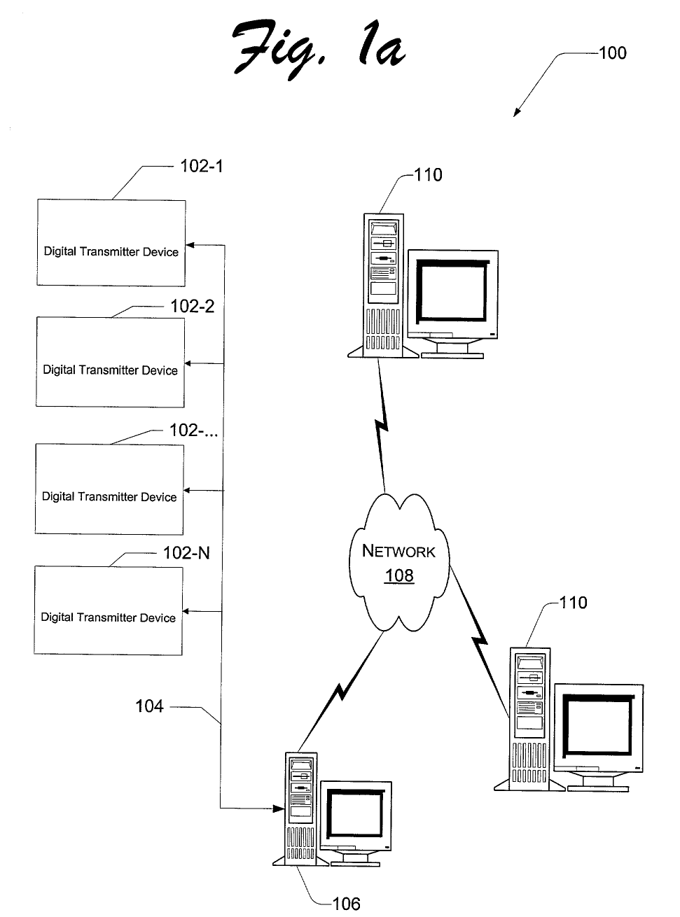

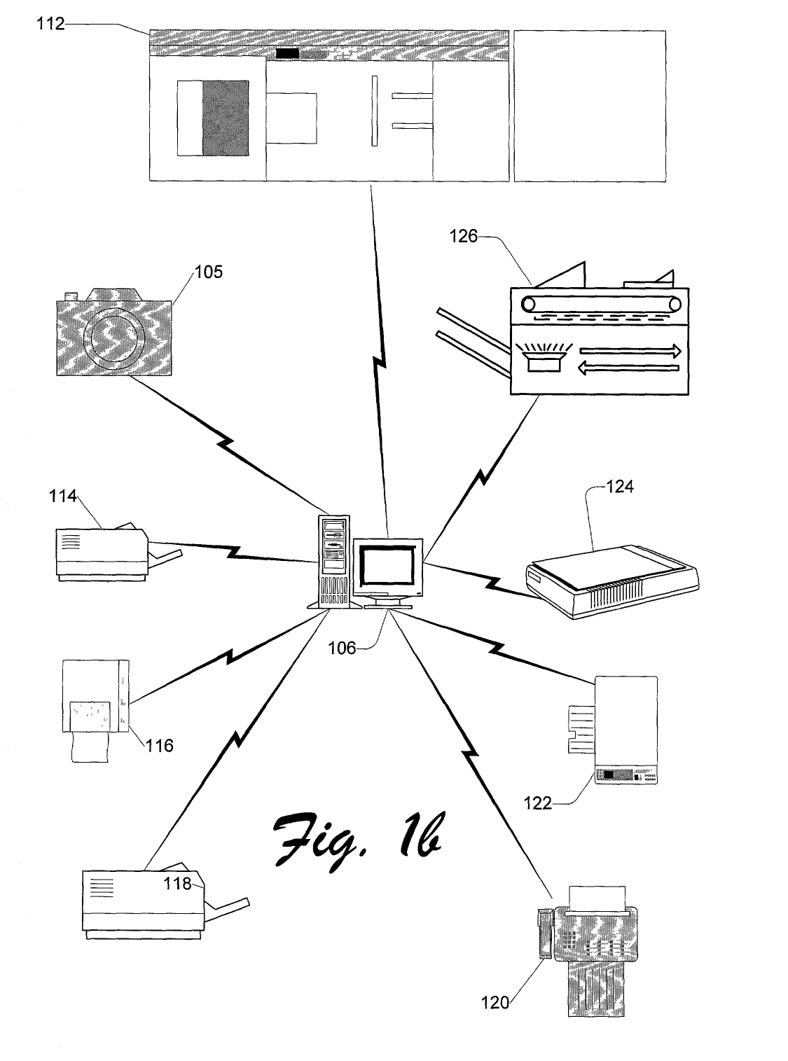

FIG. 1a illustrates an example of a system environment 100 suitable for implementing an embodiment of the present invention. The system environment 100 contemplates local access to one or more digital transmitter devices 102-1 through 102-N. The local access can be provided through an input device, such as a touch sensitive menu screen, on each digital transmitter device 102. A user accesses the input device for the purpose of entering commands and a desired e-mail address. Each digital transmitter device 102 is in communication with a network device, such as a host computer 106 through the wired or wireless link 104. Host computer 106 is in communication with one or more e-mail servers 110 through an interconnected network 108.

Digital transmitter devices 102-1 through 102-N generally include peripheral devices and stand-alone devices. Peripheral devices include devices such as printers, scanners, copiers, and fax machines, or multifunction peripheral (MFP) devices that combine two or more peripheral devices into a single device. Stand-alone devices include certain peripheral devices that often function while uncoupled or isolated from other devices. Digital transmitter devices 102 therefore include devices such as copiers, scanners and fax machines like those shown in FIG. 1b, discussed below.

Digital transmitter devices 102 are generally distinguishable from devices such as laptop PCs (personal computers) and pocket PCs by their limited purpose and limited user interface or input/output capabilities. For example, a typical user interface for a digital transmitter device 102 includes a front menu panel with limited screen space and a limited number of buttons. In addition, a digital transmitter device 102 is typically oriented toward performing one general task such as scanning. By contrast, devices such as laptop and pocket PCs often provide multiple and varied means of input/output such as a full screen display, a QWERTY keyboard, a trackball mouse, speakers, microphones, PCMCIA (Personal Computer Memory Card International Association) slots, portable media drives and the like. These devices are capable of performing multiple functions through executing various software applications such as word processing applications, spreadsheet applications, financial applications, network browsers and network messaging applications.

Interconnecting network 108 is representative of one or more communication links, either wired or wireless, that are capable of carrying data between host computer 106 and other network resources in communication with interconnecting network 108. In certain exemplary implementations, interconnecting network 108 includes a local area network (LAN), a wide area network (WAN), an intranet, the Internet, or other similar network. E-mail servers 110, as seen in FIG. 1a, are typically coupled to interconnecting network 108 through a network connection.

FIG. 1b shows a variety of digital transmitter devices that can be in communication with host computer 106 through a wired or wireless link. The digital transmitter devices shown in FIG. 1b include a camera 105 which it intended to also represent a type of portable hand held scanner. Also shown are various multifunction peripherals (MFPs) 114, 116, 118, and 122, a facsimile machine 120, a desk top scanner 124, and a high volume copier 116 that includes the capabilities of printing on substrates of varied composition, binding, collating, folding, stacking, stapling, stitching, edge-trimming, and paginating. Each digital transmitter device 105 and 112-126 has an input device to receive an e-mail address. Each digital transmitter device 105 and 112-126 also has an imaging or scanning mechanism to receive an image of an object. The input e-mail address and the image of the object can then be sent from each digital transmitter device 105 and 112-126 to host computer 106 through the wired or wireless link 104.

The user of digital transmitter device 102 can transmit message data from digital transmitter device 102 to host computer 106 by the wired or wireless link 104. A wireless transmission to host computer 106 can be through an Infrared (IR) data connection or other wireless data connections such as the Blue Tooth protocol. A wired link can be performed through a USB data connection, a serial port connection, a parallel port connection or via other known data transmission standards and modes. As such, digital transmitter device 102 can transmit to host computer 106 by one or both a wireless or wired link. By way of example, digital transmitter device 102 can include the capabilities of a cordless handset telephone, a personal digital assistant (PDA), a portable computer, a pager, a watch and the like, any of which is also capable of transmitting data in a wireless manner.

Digital transmitter device 102 typically includes a transmit port. The transmit port enables a relay of data through the wired or wireless link 104 directly to host computer 106. The wired or wireless link 104 may be made through standard RS232 cable and/or radio frequency (RF) link. The wired or wireless link 104 may also be implemented through the use of infra-red (IR) data ports. Link 104 between digital transmitter device 102 and host computer 106 may also be made through a Universal Serial Bus (USB) or “Fire Wire”™ wire connection there between.

### Exemplary Embodiment of an Apparatus for Implementing Configuration of the Same

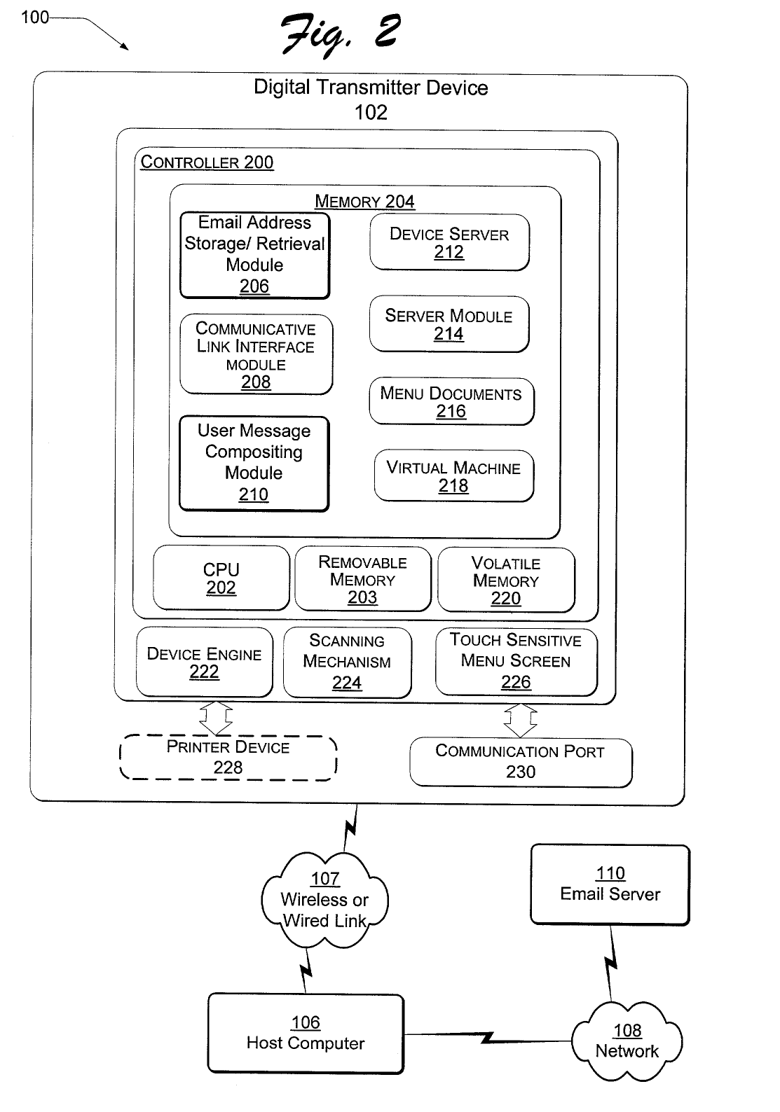

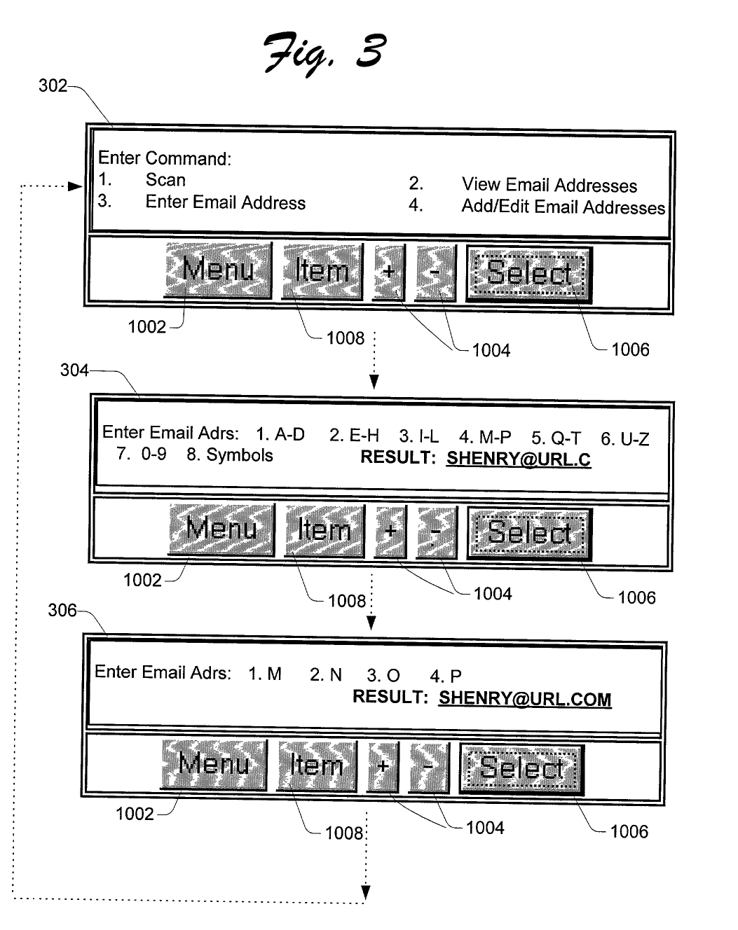

The system 100 of FIG. 2 includes digital transmitter device 102 as a peripheral device coupled by a wired or wireless link 104 to a host computer 106. Host computer 106 is coupled through an interconnecting network 108 to one or more e-mail servers 110. As such, FIG. 3 illustrates an embodiment of the system 100 of FIG. 1 in greater detail. In accordance with still other aspects of the present invention, digital transmitter device 102 may be included within a multiple function peripheral (MFP) device. As its name implies, the MFP device is configured to provide multiple functions. In this example, the functions provided by the MFP device include those provided by digital transmitter device 102 and a printer device 228. Consequently, the user of digital transmitter device 102 may also print out a hardcopy of any applicable portions of data stored or otherwise acquired by digital transmitter device 102.

In general, digital transmitter device 102 includes a controller 200 to execute a program so as to transform data received from interconnecting network 108 via host computer 106 to a driver format suitable for printing with integral printer device 228, such as a mark up language format (e.g. SMGL, HTML, or XML), or such as a job language format (e.g. PCL or postscript). Printer device 228 can have the capability of converting the host data and then outputting it onto an appropriate print media, such as paper, transparencies or glossy photo paper.

Digital transmitter device 102 includes one or more CPUs 202 each of which is operatively coupled to a memory 204, and a user interface that includes an input device. Preferably, the input device will be locally accessible at digital transmitter device 102. By way of example, the input device can be a touch sensitive menu screen 226. Digital transmitter device 102 also includes a scanning mechanism 224 and at least one communication port for interfacing with the interconnecting network 108. When included in an MFP device, CPU(s) 202 would also be operatively coupled to printer device 228, for example. CPU(s) 202 is representative of any hardware, firmware and/or software that is configured to perform certain functions associated with the operation of digital transmitter device 102. Hence, as those skilled in the art will recognize, CPU(s) 202 may include dedicated logic and/or one or more processors configured in accord with software instructions, for example.

Memory 204 is representative of any type of data storage mechanism that can be accessed by at least CPU(s) 202. Memory 204 may therefore include, for example, some form of random access memory (RAM); some form of read only memory (ROM), and/or other like solid-state data storage mechanism. Memory 204 may include a magnetic and/or optical data storage mechanism. Scanning mechanism 224 is representative of any optical scanner technology that may be employed to produce scanned object data upon scanning an object. Such scanning technologies are well known. The resulting scanned object data is provided to CPU 202 and/or stored in memory 204.

Controller 200 of digital transmitter device 102 can process data from host computer 106. The controller 200 typically includes data processing unit or CPU 202, a volatile memory 220 (i.e., RAM), and a non-volatile memory 204 (e.g., ROM, Flash). Digital transmitter device 102 also includes a device engine 222. The touch sensitive menu screen 226 acts as a local user interface for digital transmitter device 102 by displaying menu pages and accepting user input based on selectable menu items displayed on the menu pages. The touch sensitive menu screen 226 can be used to display a menu page that asks for and receives the input of an e-mail address to which to image data that is scanned with scanning mechanism 224 is to be transmitted via link 104 to host computer 106.

Controller 200 processes host data and manage device functions by controlling device engine 222 and by responding to input from touch sensitive menu screen 226. Controller 200 includes device driver software in a device server 212 that is stored in memory 204 and executed on CPU(s) 202. Memory 204 also includes a server module 214 configured to serve menu documents 216 to the touch sensitive menu screen 226. The server module 214 is a local server in the sense that it is present within the same digital transmitter device 102 to which it serves menu documents 216.

Menu documents 216 are interpreted by the server module 214 and are configured to display textual and graphical information as menu pages on the touch sensitive menu screen 226. Menu documents 216 driving the menu pages can include script code that is associated with graphical keys. The term “script code” is intended herein to mean any one of a variety of different code types. Various kinds of code are contemplated. By way of example, the code can be implemented in embedded script code, in firmware, in a native code such as C++ code, or can be JAVA script. The code can be written in JavaScript code that is interpreted and executed on a Java Virtual Machine (JVM). The code can also be written in other script code languages such as VBScript or Perl.

Selecting a menu item by pressing a graphical key on the touch sensitive menu screen 226 triggers an event which causes a “virtual machine” 218 to interpret and execute the script code associated with the selected graphical key. The virtual machine 218 is a software module stored in memory 204 that executes on CPU(s) 202 to interpret and execute script code. The script code associated with selectable menu items (i.e., graphical keys or buttons). One menu item is configured to perform the task of initiating a scan of an image using scanning mechanism 224. Another menu item is configured to perform the task of receiving input of a specific e-mail address from which e-mail message data is to sent to host computer 106 via link 104, and then from host computer 106 to a third party e-mail service 110 via interconnected network 108 as seen in FIG. 2. Still another menu item is configured to perform the task of initiating a retrieval of an e-mail address that was previously stored in an e-mail address storage/retrieval module 206. Server module 214 on digital transmitter device 102 acts as a remote server to the host computer 106, such as by serving data via link 104 that has been previously stored in an e-mail address storage/retrieval module 206. The e-mail address storage/retrieval module 206 contains e-mail address information that can be requested to be displayed upon touch sensitive menu screen 226. When the e-mail address information is retrieved from e-mail address storage/retrieval module 206, the user select a displays e-mail address to transmission over wired and/or wireless link 104 to host computer 106. Alternatively, the user can directly enter a specific e-mail address into the digital transmitter device 102 using touch sensitive menu screen 226. Controller 200 executes processes resident in a communicative link interface module 208 for transmission over wired and/or wireless link 104 to host computer 106.

When a user enters a command displayed upon touch sensitive menu screen 226 to start a scanning operation, the user places a set of documents into a sheet feeder device associated with digital transmitter device 102. The sheet feeder device then physically feeds each sheet in the set of documents to scanning mechanism 224. CPU 202 then generates a bit map or other output that is a digital representation of the scanned documents. For example, the scanned object data may be included in the e-mail message data as an attached file. The scanned object data may include Portable Document Format (PDF) formatted data, graphic image file format (GIFF) formatted data, tagged image file format (TIFF) formatted data, Joint Photographic Experts Group (JPEG) formatted data, bit-map formatted data, optical character recognition (OCR) related data, American Standard Code for Information Interchange (ASCII) formatted data, and/or other forms of encoded data, including, e.g., encrypted data, etc.

When the user enters a command displayed upon touch sensitive menu screen 226 to enter or retrieve an e-mail address, digital transmitter device 102 coordinates the input of the e-mail address. Controller 200 then executes a user message compositing module 210 that assemblies message data. The message data so assembled by the user message compositing module 210 includes the e-mail address input or otherwise designated by the user, the bit map or other output that is a digital representation of the scanned documents, instructions for host computer 106 to send all or a portion of the message data to the e-mail address, and can also include any message text entered by the user upon touch sensitive menu screen 226. The message data is then sent by wired and/or wireless link 104 to host computer 106.

CPU(s) 202 is configured to perform the operations described above using various executable modules of memory 204. The e-mail address storage/retrieval module 206, the communicative link interface module 208, and the user message compositing module 210 can each be implemented in software or firmware.

In one embodiment of the invention, e-mail address storage/retrieval module 206 receives input of an e-mail address from a user at touch sensitive menu screen 226 or retrieves a list of stored e-mail addresses. The list of e-mail addresses are displayed on touch sensitive menu screen 226 in a hierarchical list. The list can be sorted alphanumerically. The user can either select from among the displayed e-mail addresses or input the characters of a specific e-mail address using a ‘drill-down’ function of the menu, as discussed below with respect to FIG. 3. The drill-down menu format and the displayed list of retrieved e-mail addresses assist the user in locating one or just a few email addresses of interest.

An example of a ‘drill-down’ function on a displayed menu, in accordance with an embodiment of the present invention, is now discussed with respect to FIG. 3. A menu screen 302 is displayed upon touch sensitive menu screen 226 of digital transmitter device 102. Menu screen 302 shows various options to be selected by a user of digital transmitter device 102. When the user selects option “1”, digital transmitter device 102 activates scanning mechanism 224 to scan in documents as discussed above. When the user selected option “3”, menu screen 304 is displays and receives input from the user directly entering each character of a desired e-mail address using virtual buttons displayed upon menu screens 304-306.

After menu screen 302, menu screen 304 is displayed upon touch sensitive menu screen 226 of digital transmitter device 102. Menu screen 304 shows a practical example of a user selecting characters for a desired e-mail address. Menu screen 304 is presented by script code executing in CPU(s) 202 that allows the user to see alphabetic and symbolic characters by depressing virtual buttons 1004 to move forward and backward through a displayed hierarchical list of available alphabetic and symbolic characters. Script code executes in CPU(s) 202 to enable a user to select a displayed character by depressing virtual button 1006. The user can select a sequence of characters by depressing virtual buttons 1004 to thereby move forward and backward through the sequence of characters. Alphabetic and symbolic sequences of characters can be selected by the user on menu screen 302. By depressing virtual button 1006, the user can select a particular sequence of characters that is displayed. Menu screen 304 shows that a user has entered a partial e-mail address “SHENRY@URL.C”.

As seen in menu screen 306, the sequence of characters ‘M-P’ has been selected by the user by depressing virtual button 1006. The user then select one character of characters M-P by depressing virtual buttons 1004 to thereby move forward and backward through the characters M-P. Menu screen 306 shows that the characters “O” and “M” where selected from the characters M-P so as to complete the desired e-mail address “SHENRY@URL.COM”. Then, when virtual button 1006 is depressed on menu screen 306, the user sees a transition back to menu screen 302 where the user can enter another command as discussed above. Digital transmitter device 102 then assembles message data to be sent to host computer 106 through link 104 along with instructions to host computer 106 to transmit the message data over interconnected network 108 to the e-mail address that was selected or otherwise entered by the user, as discussed above. Other virtual buttons on the touch sensitive menu screen 226 are also contemplated in order to provide for the initiation of other or additional functions by the user, such as an item virtual item button 1008 seen in FIG. 3.

### Exemplary Embodiment of Digital Transmitting From Remote Capture

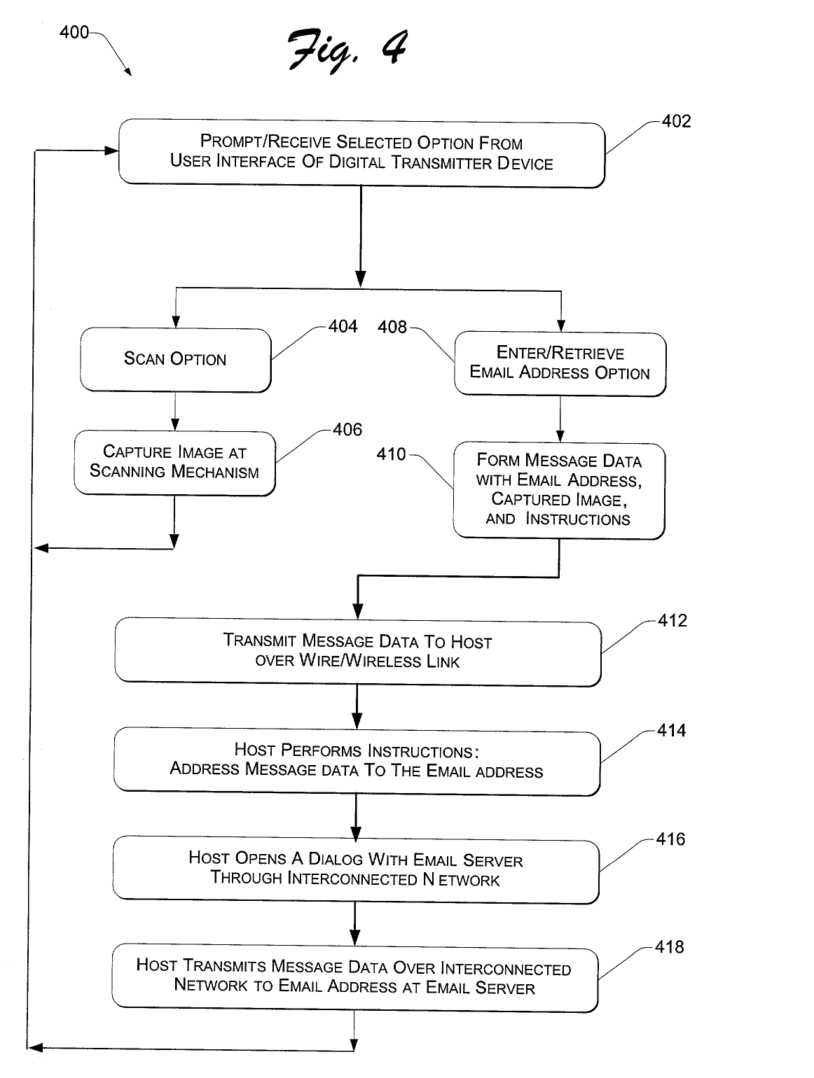

With this in mind, CPU(s) 202 can be configured to perform the operations described above. By way of further example, a flow diagram is depicted in FIG. 4 to illustrate certain exemplary functions that can be performed using CPU 202 and the other resources in digital transmitter device 102. Here, a process 400 is provided.

In step 402, digital transmitter device 102 displays a prompt upon touch sensitive menu screen 226. In order to display the prompt, it is preferably that the server module 214 of memory 204 in digital transmitter device 102 serves a menu page that is stored in menu documents 216 to CPU 202 for execution of script code. The script code being executed by CPU 202 effects a function to be performed by digital transmitter device 202, such as receiving input from a user that is entered upon touch sensitive menu screen 226, or the initiation of a function by the user depressing a function related virtual button that is displayed upon touch sensitive menu screen 226. The script code will preferably be executed in conjunction with an interpretation of the menu page. Note that in certain implementations, the menu page can be directly interpreted by script code executing on CPU 202 without any prior storage in menu documents 216 or use of server module 214 in digital transmitter device 102. The prompt on the menu screen 302 at step 402 solicits input from a user of a command, as discussed above with respect to FIG. 3. At step 404, the user has selected the scanning command whereby the scanning mechanism 224 scans in documents and captures images therefrom at step 406. At step 408, the user has selected the option to input an e-mail address whereby digital transmitter device 102 then prompts and receives input of an e-mail address from the user on menu screen 304 seen in FIG. 3. At step 410, message data is assembled by controller 200 executing user message compositing module 210. The message data so assembled by the user message compositing module 210 includes the e-mail address input or otherwise designated by the user, the bit map or other output that is a digital representation of the scanned documents captured by scanning mechanism 224, instructions for host computer 106 to send all or a portion of the message data to the e-mail address, and can also include any message text entered by the user upon touch sensitive menu screen 226. At step 412, controller 200 executes processes resident in a communicative link interface module 208 for transmission of the assembled message data over wired and/or wireless link 104 to host computer 106.

At step 414, host computer 106 addresses the message data to the e-mail address as per instructions received from digital transmitter device 102. Alternatively, a default e-mail address can be used in which case no input is required from the user, such as where a digital transmitter device is dedicated to digital transmitting to one particular e-mail mail address. At step 416, host computer 106 opens a dialog via interconnected network 108 with an e-mail server associated with the e-mail address so designated. At step 418, host computer 106 transmits some or all of the message data to third party e-mail server 110 over interconnected network 108. Thus, process 400 can be accomplished without digital transmitter device 102 ever having to log on to interconnected network 108, or to be a network device.

In an embodiment of the present invention, a digital transmitter device has IR transmission capabilities and a small or otherwise portable scan head to scan in text or other images. A user of the digital transmitter device could then use the digital transmitter device portably and scan in a collection of documents remotely for storage at the digital transmitter device. At a later time, the user could input or otherwise specific an e-mail address to which the scanned documents are to be sent. At a still later time, such as when the digital transmitter device is in range with an IR network with the host computer, the user can digitally send the captured images in message data over an IR link to the host computer. The message data sent from the digital transmitter device would also include instructions to the host computer to e-mail message the scanned images in the message data to the designated e-mail address.

Accordingly, methods, apparatuses, systems, and programs are provided that allow for the digital transmitting of documents that were remotely captured to an e-mail address, where the transmission to the e-mail address is performed by a network device other than the digital transmitter device. Embodiments of the present invention minimize requirements for the host computer because a digital transmitter device is separately used to scan images that the digital transmitter device puts into a file with a designated e-mail address. Once the digital transmitter device links to the host computer, the file is sent to the host computer. The host computer is in communication with an interconnected network so that it can then connect to a corresponding e-mail service and send an e-mail message with the scanned documents in an attached file, where the e-mail message is sent to the e-mail address designated by the digital transmitter device. As such, the host computer is used for little because the digital transmitter device performs most of the task to address and prepare the message data for sending to the e-mail address.

The foregoing Detailed Description has set forth an example of transmitting an email message from a digital transmitter device. Embodiments of the present invention contemplate other types of data that can also be addressed and transmitted from a digital transmitter device to an electronic address, including those now known and those yet to be developed. As such, and in addition to an e-mail message transmission, embodiments of the present invention include a transmission from a digital sender device to an electronic address that includes an address of a network resource on a network and a destination location thereat. By of example, and not by way of limitation, the electronic address can be a file folder address at a server on a network and can also be a Web site address at a server on a network.

Thus, although some preferred embodiments of the various methods, apparatuses, systems, and programs of the present invention have been illustrated in the accompanying Drawings and described in the foregoing Detailed Description, it will be understood that the invention is not limited to the exemplary implementations disclosed, but is capable of numerous rearrangements, modifications and substitutions without departing from the scope of the invention as set forth and defined by the following claims.

What is claimed is:

1. A computer-readable medium having computer-executable instructions which, when executed on a processor of a digital transmitter device, direct the digital transmitter device to perform a method comprising:
capturing an image with the digital transmitter device; and
transmitting from the digital transmitter device to a network device capable of sending data on a network:
the captured image;
a designated electronic address including an address of a network resource and a destination location thereat; and
instructions to the network device to transmit the captured image over the network to the designated electronic address.

2. The computer-readable medium as defined in claim 1, further comprising receiving the designated electronic address with the digital transmitter device.

3. The computer-readable medium as defined in claim 2, wherein the digital transmitter device has an input device and the method further comprises receiving via the input device the designated electronic address.

4. The computer-readable medium as defined in claim 3, wherein the input device is selected from the group consisting of a keyboard and a touch sensitive menu screen.

5. The computer-readable medium as defined in claim 4, wherein:
the touch sensitive menu screen of the scanner displays a menu page having selectable menu items that include:
a menu item to input the designated electronic address; and
a menu item to perform a scan function;
the processor of the digital transmitter device executes respective programs associated with each said selected menu item; and
the selection of one said menu item initiates the execution of one said respective program by the processor.

6. The computer-readable medium as defined in claim 1, wherein the capturing an image with a digital transmitter device comprises:
optically scanning at least one object to form corresponding scanned object data; and
forming in message data the designated electronic address and the scanned object data.

7. The computer-readable medium as defined in claim 6, wherein the transmitting from the digital transmitter device to a network device capable of sending data on a network comprises transmitting over a channel established by one of a wireless link and a wired link.

8. The computer-readable medium as defined in claim 1, wherein the method further comprising:
opening a connection with the network resource for the designated electronic address;
10017575-1
addressing said message data using said designated electronic address; and
transmitting said message data from the network device to the designated electronic address.

9. The computer-readable medium as defined in claim 1, wherein the designated electronic address is selected from the group consisting of:
an electronic mail (e-mail) address at an e-mail server on a network;
a file folder address at a server on a network; and
a Web site address at a server on a network.

10. A computer-readable medium having computer-executable instructions which, when executed on one or more processors of a computing system, direct the computing system to perform a method comprising:
optically scanning at least one object to form corresponding scanned object data at a scanner having an input device;
receiving, using the input device of the scanner, an input of a designated electronic address including an address of a network resource and a destination location thereat;
forming in message data the designated electronic address and the scanned object data;
transmitting the message data over a link along with instructions;
receiving the message data over the link at a network device in communication with a network, wherein the instructions direct the network device to transmit the message data over the network to the designated electronic address;
wherein the network device, in response to the instructions:
opens a connection with the network resource for the designated electronic address, wherein the network resource is in communication with the network;
addresses the message data using the designated electronic address; and
transmits the message data from the network device over the network to the network resource for the designated electronic address.

11. The computer-readable medium as defined in claim 10, wherein the designated electronic address is selected from the group consisting of:
an e-mail address at an e-mail server on a network;
a file folder address at a server on a network; and
a Web site address at a server on a network.

12. A digital transmitter device comprising:
a scanner mechanism configurable to optically scan at least one object to form corresponding scanned object data;
logic configured to form message data including the scanned object data and a requested electronic address including an address of a network resource and a destination location thereat; and
a communicative link to a network device capable of sending the message data to the requested electronic address on a network along with instructions to the network device to transmit the message data over the network to the designated electronic address.

13. The digital transmitter device as defined in claim 12, further comprising an input device for receiving the requested electronic address, wherein the logic is operatively coupled to the input device.

14. The digital transmitter device as defined in claim 13, wherein the input device is selected from the group consisting of a keyboard and a touch sensitive menu screen.

15. The digital transmitter device as defined in claim 14, wherein:
the touch sensitive menu screen displays a menu page having selectable menu items that include:
a menu item to input the requested electronic address; and
a menu item to initiate the scanning mechanism to optically scan
at least one object to form corresponding scanned object data;
the logic includes execution of respective programs associated with each said selected menu item; and
the selection of one said menu item initiates the execution of at least one said respective program by the logic.

16. The digital transmitter device as defined in claim 12, further comprising a device for providing the communicative link and selected from the group consisting of a cordless handset telephone, a pager, a cellular telephone, a radio frequency (RF) transmitter, an infrared (IR) transmitter, and a two-way radio.

17. The digital transmitter device as defined in claim 12, wherein the communicative link is at least one of packet switched and circuit switched.

18. The digital transmitter device as defined in claim 12, wherein the communicative link is selected from the group consisting of a cable, a radio frequency (RF) link, and an infra-red (IR) link.

19. The digital transmitter device as defined in claim 12, wherein the logic includes a memory for storing the requested electronic address.

20. The digital transmitter device as defined in claim 12, wherein the requested electronic address is selected from the group consisting of:
an e-mail address at an e-mail server on a network;
a file folder address at a server on a network; and
a Web site address at a server on a network

21. A digital transmitter device to scan and send an image along with instructions to a network device to transmit the image to an electronic address, including an address of a network resource and a destination location thereat, designated by the digital transmitter device.

22. The digital transmitter device as defined in claim 21, where the electronic address is associated with the network resource in communication with the network device through a network.

23. The digital transmitter device as defined in claim 21, further comprising a memory for at least one recipient address data list, said recipient address data list comprising a plurality of recipient addresses associated with a plurality of potential message data recipients each of which can be designated by the digital transmitter device to be the designated electronic address.

24. The digital transmitter device as defined in claim 21, wherein the digital transmitter device is selected from the group consisting of a digital camera, a hand held scanner, a desk top scanner, a fax machine, a copier, a multifunction peripheral (MFP), and a digital network copier.

25. The digital transmitter device as defined in claim 21, wherein the electronic address is selected from the group consisting of:
an e-mail address at an e-mail server on a network;
a file folder address at a server on a network; and
a Web site address at a server on a network

26. A data sending system comprising:
a digital transmitter device including means for:
transmitting message data over a communicative link;
receiving input of a requested electronic address including an address of a network resource and a destination location thereat;
optically scanning at least one object to form corresponding scanned object data; and
forming the message data to include the scanned object data, the
requested e-mail address, and instructions to transmit the message data to the requested electronic address;
means for receiving the message data over the communicative link; and
sending means for sending, in response to the instructions, the message data to the requested electronic address associated with the network resource in communication with a network with which said sending means is in communication.

27. The data sending system as defined in claim 26, wherein the requested electronic address is selected from the group consisting of:
an e-mail address at an e-mail server on a network;
a file folder address at a server on a network; and
a Web site address at a server on a network

28. A data sending system comprising:
an interconnected network in communication with a network resource;
a digital transmitter device that includes:
an input device to receive input of a requested electronic address of the network resource and a destination location thereat;
a hand held scanning device to optically scanning at least one object to form corresponding scanned object data;
logic to form message data to include the scanned object data, the requested electronic address, and instructions to transmit the message data to the requested electronic address; and
a transmitter to transmit the message data over a wireless link;
a network device, in communication through the interconnected network with the network resource, capable of:
receiving the message data from the wireless link; and
transmitting, in response to the instructions, the message data to the network resource for the requested electronic address on the interconnected network.

29. The data sending system as defined in claim 28, wherein the requested electronic address is selected from the group consisting of:
an e-mail address at an e-mail server on a network;
a file folder address at a server on a network; and
a Web site address at a server on a network

30. In a digital transmitter device that includes a memory, a portable scanning mechanism configurable to optically scan at least one object to form corresponding scanned object data, an input device to the memory to receive a user input, a wireless interface to send message data, and logic that is operatively coupled to the memory and to the wireless interface, wherein the logic is configurable to form in the message data said scanned object data and said user input, and wherein the logic is configurable to execute a program embodied on a computer-readable medium, the program comprising:
a code segment to receive at the input device the user input that includes a requested electronic address including an address of a network resource and a destination location thereat; and
a code segment to transmit the message data to a network device over the wireless interface along with instructions to the network device to transmit the message data over a network in communication with the network resource to the requested electronic address.

31. The program as defined in claim 30, wherein the requested electronic address is selected from the group consisting of:
an e-mail address at an e-mail server on a network;
a file folder address at a server on a network; and
a Web site address at a server on a network.

32. A transmitter device comprising:
a scanner mechanism configurable to optically scan at least one object to form corresponding scanned object data;
logic configured to form message data including the scanned object data and a requested electronic address including an address of a network resource and a destination location thereat; and
a communicative link to a network device capable of sending the message data to the requested electronic address on a network along with instructions to the network device to transmit the message data over the network to the designated electronic address.

33. The transmitter device as defined in claim 32, further comprising an input device for receiving the requested electronic address, wherein the logic is operatively coupled to the input device.

34. The transmitter device as defined in claim 32, further comprising a device for providing the communicative link and selected from the group consisting of a cordless handset telephone, a pager, a cellular telephone, a radio frequency (RF) transmitter, an infrared (IR) transmitter, and a two-way radio.

35. The transmitter device as defined in claim 32, wherein the communicative link is at least one of packet switched and circuit switched.

36. The transmitter device as defined in claim 32, wherein the communicative link is selected from the group consisting of a cable, a radio frequency (RF) link, and an infra-red (IR) link.

37. The transmitter device as defined in claim 32, wherein the logic includes a memory for storing the requested electronic address.
